(19) United States
(12) Patent Application Publication
(10) Pub. No.: US 2019/0255542 A1
(43) Pub. Date: Aug. 22, 2019

(54) DRIP IRRIGATION CONTROL ASSEMBLY

(71) Applicant: Jerry Bitterman, Sequim, WA (US)

(72) Inventor: Jerry Bitterman, Sequim, WA (US)

(21) Appl. No.: 15/900,181

(22) Filed: Feb. 20, 2018

(51) Int. Cl. B05B 1/30; A01G 25/02

(52) U.S. Cl. CPC B05B 1/30; A01G 25/023

(57) ABSTRACT

A drip irrigation control assembly for selectively turning off nipples on a drip irrigation system includes nipple that is fluidly coupled to a drip irrigation tube for irrigating a plant. A cap is positionable on the nipple to inhibit a fluid from dripping from the nipple. A pair of wings is provided and each of the wings is coupled to and extends outwardly from the cap for gripping and twisting the cap.

### CROSS-REFERENCE TO RELATED APPLICATIONS

### Statement Regarding Federally Sponsored Research or Development

Not Applicable

### The Names of the Parties to a Joint Research Agreement

Not Applicable

### Incorporation-by-Reference of Material Submitted on A Compact Disc or as a Text File Via the Office Electronic Filing System

Not Applicable

### Statement Regarding Prior Disclosures by the Inventor or Joint Inventor

Not Applicable

### BACKGROUND OF THE INVENTION

### (1) Field of the Invention

### (2) Description of Related Art Including Information Disclosed Under 37 CFR 1.97 and 1.98

The disclosure and prior art relates to control devices and more particularly pertains to a new control device for selectively turning off nipples on a drip irrigation system.

### BRIEF SUMMARY OF THE INVENTION

An embodiment of the disclosure meets the needs presented above by generally comprising a nipple that is fluidly coupled to a drip irrigation tube for irrigating a plant. A cap is positionable on the nipple to inhibit a fluid from dripping from the nipple. A pair of wings is provided and each of the wings is coupled to and extends outwardly from the cap for gripping and twisting the cap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cap of a drip irrigation control assembly according to an embodiment of the disclosure.

FIG. 2 is a front phantom view of a cap of an embodiment of the disclosure.

FIG. 3 is a perspective view of an embodiment of the disclosure.

### DETAILED DESCRIPTION OF THE INVENTION

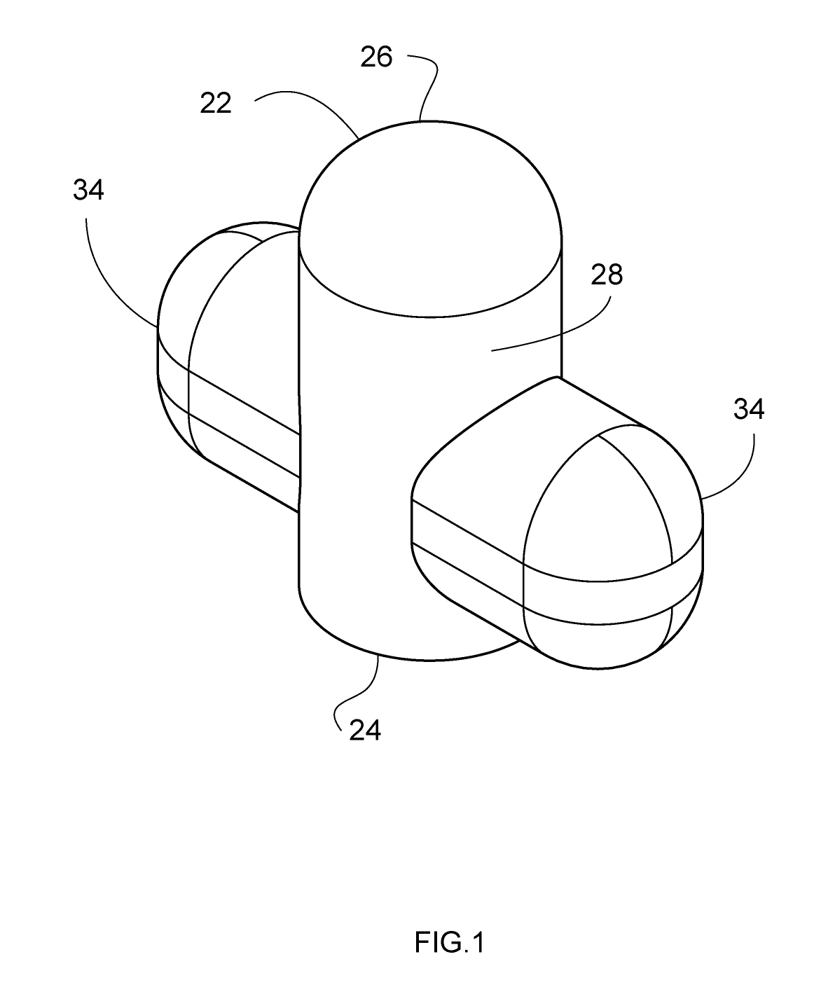

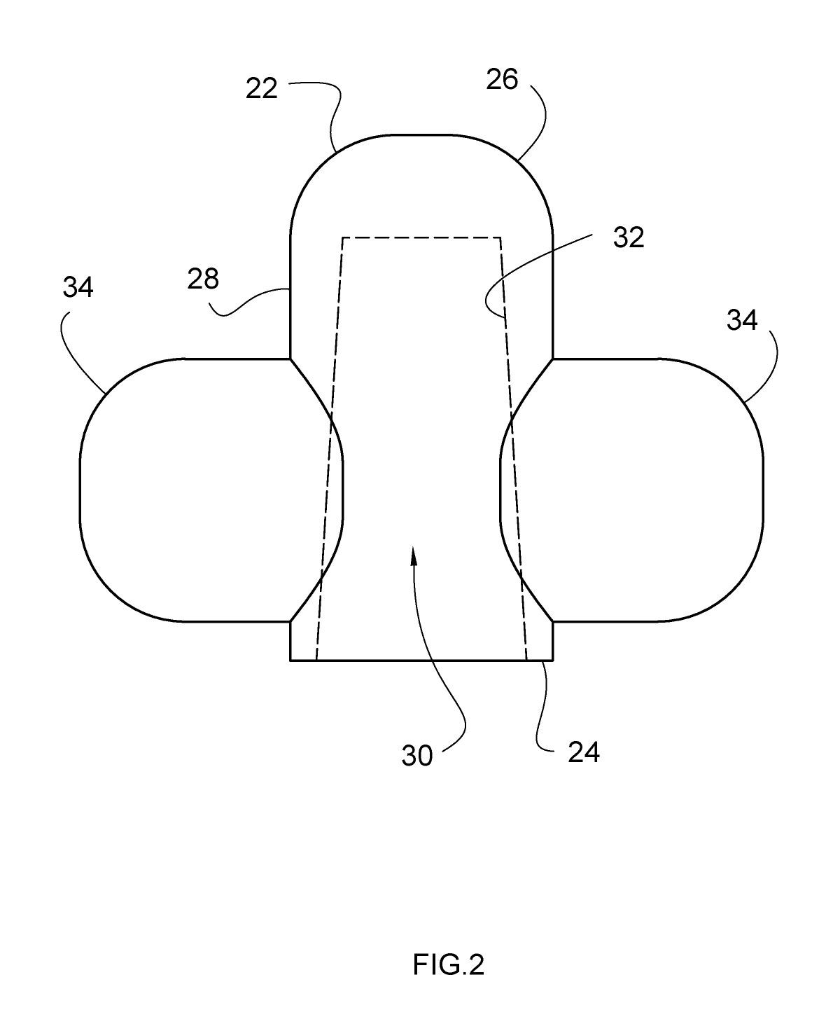

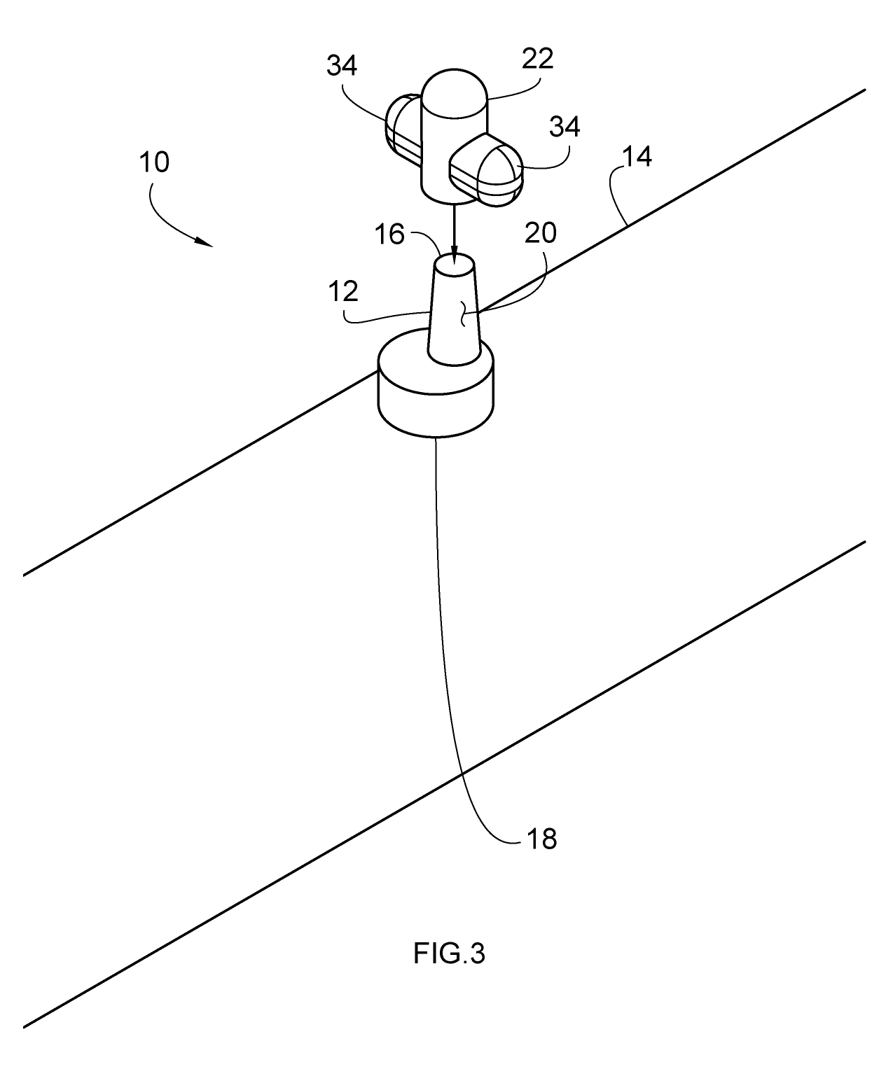

With reference now to the drawings, and in particular to FIGS. 1 through 3 thereof, a new control device embodying the principles and concepts of an embodiment of the disclosure and generally designated by the reference numeral 10 will be described.

As best illustrated in FIGS. 1 through 3, the drip irrigation control assembly 10 generally comprises a nipple 12 that may be fluidly coupled to a drip irrigation tube 14 for irrigating a plant. The drip irrigation tube 14 may be part of a larger drip irrigation system for irrigating a lawn and flowerbeds at a residence or the like. The plant may be grass in the lawn, flowers in the flowerbed and any other plant. The nipple 12 has a first end 16, a second end 18 and an outer surface 20 extending therebetween. The nipple 12 is hollow and the first end 16 is open to release a fluid for irrigation such as water, liquid fertilizer and any other horticultural fluid. The second end 18 is attached to the drip irrigation tube 14. Moreover, the outer surface 20 tapers inwardly between the second end 18 and the first end 16 such that the nipple 12 has a conical shape.

A cap 22 is positionable on the nipple 12 to inhibit the fluid from dripping from the nipple 12. In this way a selected area along the drip irrigation tube 14 can be inhibited from being irrigated thereby facilitating customizable irrigation applications with a conventional drip irrigation system. Moreover, a plurality of the nipples 12 may be provided and the nipples 12 may be distributed along the drip irrigation tube 14. A plurality of the caps 22 may be provided and each of the caps 22 may be selectively placed on selected nipples 12. In this way each of the nipples 12 can be turned on and off without requiring any additional equipment and without requiring any structural changes to conventional drip irrigation systems.

The cap 22 has a primary end 24, a secondary end 26 and an outer wall 28 extending therebetween. The primary end 24 has a well 30 extending towards the secondary end 26 and the well 30 has a bounding surface 32. The bounding surface 32 tapers inwardly between the primary end 24 and the secondary end 26 such that the well 30 has a conical cross-section taken perpendicular to a line extending through the primary end 24 and the secondary end 26. The well 30 insertably receives the nipple 12 having the outer surface 20 of the nipple 12 frictionally engaging the bounding surface 32 of the well 30. Moreover, the cap 22 may be comprised of a resiliently stretchable material, such as rubber, such that the cap 22 forms a fluid impermeable seal with the nipple 12.

The cap 22 includes a pair of wings 34. Each of the wings 34 is coupled to and extends outwardly from the outer wall 28 of the cap 22. Moreover, each of the wings 34 may be gripped for twisting and removing the cap 22 from the nipple 12. The wings 34 are positioned on opposite sides of the cap 22 with respect to each other.

In use, each of the caps 22 is selectively placed on a selected nipple 12 to inhibit the fluid from dripping from the selected nipple 12. In this way the selected nipple 12 is effectively turned off without the necessity of adding a valve or making structural changes to the drip irrigation system. Additionally, the caps 22 may be arranged in patterns thereby facilitating customizable irrigation with an un-modified, conventional drip irrigation system. Entire sections of the drip irrigation system can be turned off without removing the sections of the drip irrigation system. Thus, the sections can be turned back on at a later time for subsequent re-use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drip irrigation control assembly being configured to selectively close nipples on a drip irrigation system, said assembly comprising:
a nipple being fluidly coupled to a drip irrigation tube for irrigating a plant;
a cap being positionable on said nipple wherein said cap inhibits a fluid from dripping from said nipple; and
a pair of wings, each of said wings being coupled to and extending outwardly from said cap wherein each of said wings is configured to be gripped for twisting said cap.

2. The assembly according to claim 1, wherein said nipple has a first end, a second end and an outer surface extending therebetween, said nipple being hollow, said first end being open to release a fluid for irrigation, said second end being attached to the drip irrigation tube.

3. The assembly according to claim 2, wherein said outer surface tapers inwardly between said second end and said first end such that said nipple has a conical shape.

4. The assembly according to claim 1, wherein said cap has a primary end, a secondary end and an outer wall extending therebetween, said primary end having a well extending towards said secondary end.

5. The assembly according to claim 4, wherein said well has a bounding surface, said bounding surface tapering inwardly between said primary end and said secondary end such that said well has a conical cross-section taken perpendicular to a line extending through said primary end and said secondary end.

6. The assembly according to claim 4, wherein said well insertably receives said nipple having an outer surface of said nipple frictionally engaging said bounding surface of said well such that said cap forms a fluid impermeable seal with said nipple.

7. A drip irrigation control assembly being configured to selectively close nipples on a drip irrigation system, said assembly comprising:
a nipple being fluidly coupled to a drip irrigation tube for irrigating a plant, said nipple having a first end, a second end and an outer surface extending therebetween, said nipple being hollow, said first end being open wherein said first end is configured to release a fluid for irrigation, said second end being attached to the drip irrigation tube, said outer surface tapering inwardly between said second end and said first end such that said nipple has a conical shape;
a cap being positionable on said nipple wherein said cap inhibits a fluid from dripping from said nipple, said cap having a primary end, a secondary end and an outer wall extending therebetween, said primary end having a well extending towards said secondary end, said well having a bounding surface, said bounding surface tapering inwardly between said primary end and said secondary end such that said well has a conical cross-section taken perpendicular to a line extending through said primary end and said secondary end, said well insertably receiving said nipple having said outer surface of said nipple frictionally engaging said bounding surface of said well such that said cap forms a fluid impermeable seal with said nipple; and
a pair of wings, each of said wings being coupled to and extending outwardly from said outer wall of said cap wherein each of said wings is configured to be gripped for twisting said cap, said wings being positioned on opposite sides of said cap with respect to each other.
